(19) United States
(12) Patent Application Publication
(10) Pub. No.: US 2026/0208705 A1
(43) Pub. Date: Jul. 23, 2026

(54) MOBILE WORKING MACHINE, AND METHOD FOR CONTROLLING A SAFETY FUNCTION OF THE MOBILE WORKING MACHINE

(71) Applicant: ZF CV Systems Global GmbH, Bern (CH)

(72) Inventors: Mirko Brutt, Springe (DE); Dennis Sabelhaus, Luhden (DE); Jan Spremberg, Wennigsen (DE)

(73) Assignee: ZF CV Systems Global GmbH, Bern (CH)

(21) Appl. No.: 19/140,543

(22) PCT Filed: Nov. 20, 2023
(86) PCT No.: PCT/EP2023/082326

§ 371 Date: Jun. 18, 2025

(30) Foreign Application Priority Data
Dec. 19, 2022 (DE) 10 2022 213 836.8

(51) Int. Cl. B60T 7/22; E02F 9/20; E02F 9/22

(52) U.S. Cl. CPC B60T 7/22; E02F 9/2083; E02F 9/226; B60T 2201/022

(57) ABSTRACT

A mobile working machine bas a front-loading mechanism with a loading device that can be raised and lowered, a hydraulic or pneumatic brake unit with at least one electronically controlled brake circuit, and a central control unit for controlling the brake circuit at least indirectly and can operate a safety function of the working machine. To carry out the safety function and avoid a collision with an obstacle ahead, the working machine has a forward-looking monitoring device with at least one distance sensor at the front and for determining the distance from an obstacle ahead of the working machine, and has a front load monitoring device with a set position sensor on the front-loading mechanism. Via the distance sensor(s) at the front of the working machine, the distance is determined to an obstacle ahead. A warning signal can be emitted and/or an emergency braking operation initiated.

### RELATED APPLICATIONS

This application claims the benefit under 35 U.S.C. § 371 as a U.S. National Phase Application of application no. PCT/BP2023/082326, filed on 20 Nov. 2023, which claims the benefit of German Patent Application no. 10 2022 213 836.8 filed on 19 Dec. 2022, the contents of which are hereby incorporated herein by reference in their entireties.

### FIELD OF THE DISCLOSURE

The invention relates to a mobile, i.e., self-driving working machine, with a front-loading mechanism that comprises a loading device which can be raised and lowered, with a hydraulic or pneumatic brake device that comprises at least one electronically controlled brake circuit, and with a central control unit by means of which the brake circuit can be controlled, at least indirectly, and a safety function of the working machine can be operated. In addition, the invention relates to a method for controlling such a safety function of such a working machine, by virtue of which a collision with an obstacle ahead of the working machine can be avoided.

### BACKGROUND

Depending on their design, mobile working machines such as tractors, wheel loaders, fork-lift trucks, and telehandlers are often provided with a front-loading mechanism which comprises a loading device that can be raised and lowered, such as a loading scoop or a loading fork. To take up the load the load to be taken up, such as a heap of bulk material or a pallet with objects stacked on it, is approached with the loading device lowered until contact is made by carefully moving forward at a low speed. To unload the load taken up, the place where the load was taken up is first left by reversing with the loading device raised and the unloading location, such as the load platform of a truck or trailer or the load-bearing surface of a storage shelf system, is approached by driving forward. During this, apart from anything else due to restricted visibility for the driver because the loading mechanism is raised, an unintended collision may take place between the working machine, in particular its loading device and an obstacle such as the truck, a trailer vehicle, or the shelving unit. Furthermore, a certainly unintended approach to a person present in the unloading area can happen. Such a collision can result in damage to the working machine itself and to other equipment, or personal injury, and should therefore be avoided.

Driver assistance systems, mainly of motor vehicles intended for road traffic and methods for their control, are already known, with which vehicle-internal data and vehicle-external data about the surroundings of the vehicle are determined and evaluated, at least in part by sensor systems. If the evaluation of such data indicates that there is a risk of collision with an obstacle ahead of the vehicle, an emergency braking operation of the motor vehicle is initiated and carried out

Thus, in DE 10 2014 004 110 A1 a method for operating an autonomously working driving safety or driver assistance system of a motor vehicle is described, which can act as an emergency braking system. When an emergency braking function is used it is provided that an emergency braking operation is initiated and carried out if the evaluation of vehicle-internal and vehicle-external data determined at least partially by sensor means indicates an imminent risk of collision with a vehicle driving ahead or with a positionally fixed obstacle.

From DE 10 2017 100 980 A1 a method is known for automatically carrying out an emergency braking operation of a motor vehicle, in which vehicle-internal and vehicle-external parameters are determined and evaluated. The method provides that an emergency braking operation is carried out if, by virtue of the evaluation of the vehicle-internal and vehicle-external parameters, a hazardous situation is recognized.

### SUMMARY

Against that background, the purpose of the present invention is to propose a mobile working machine of the type mentioned to begin with, which comprises a device for avoiding a collision with an obstacle ahead of the working machine. In addition, a method for controlling a safety function of such a working machine should be indicated, by virtue of which a collision with an obstacle ahead of the working machine can be avoided.

These objectives are achieved by a mobile working machine and methods for operating the same as disclosed herein. Advantageous embodiments will be apparent from the present disclosure.

According to these objectives, the invention first relates to a working machine with a front-loading mechanism comprising a loading device that can be raised and lowered, with a hydraulic or pneumatic brake unit comprising at least one electronically controlled brake circuit, and with a central control unit by means of which the brake circuit can be controlled, at least indirectly, and a safety function of the working machine can be operated.

To achieve the equipment-related objective it is provided that in order to carry out the safety function and thereby to avoid a collision with an obstacle ahead of the working machine, the following components are additionally present and are connected for the exchange of signals with the central control unit:
a forward-looking monitoring device with at least one distance sensor arranged on the front of the working machine for determining the distance of the working machine from an obstacle ahead of the working machine, and
a front load monitoring device with a set position sensor arranged on the front-loading mechanism in order to determine the current position of the loading device.

Thus, the invention starts with a mobile, i.e., self-driving working machine such as a tractor, a wheel loader, a fork-lift truck, or a telehandler, which comprises a front-loading mechanism with a loading device that can be raised and lowered, such as a loading scoop or a loading fork, and a hydraulic or pneumatic brake unit with at least one electronically controlled brake circuit. In addition, there is a central control unit by means of which the brake circuit can be controlled, at least indirectly, and a safety function of the working machine can be operated.

By virtue of the electronically controlled brake circuit of the brake unit, as the safety function it is possible to trigger an emergency braking operation electronically. By means of the distance sensor of the forward-looking monitoring device the distance to an obstacle ahead of the working machine can be determined, so that an acoustic or visual warning signal can be emitted and/or an emergency braking operation can be initiated and carried out if the current distance to the obstacle is equal to or less than a critical distance. By means of the set position sensor of the front load monitoring device the current position of the loading device can be determined and thereby it can be determined whether the loading device is inside or outside the detection range of the distance sensor. Depending on the result of these determinations it can be decided whether the safety function concerned is activated or deactivated in order to avoid a collision with an obstacle ahead of the working machine.

Since the driving speed of mobile working machines is relatively low and the distances to other vehicles and positionally fixed obstacles in the working environment of mobile working machines are comparatively small, the distance sensor of the forward-looking monitoring device is preferably in the form of an ultrasonic sensor. The distance sensor is connected to the electronic control unit by an electric sensor line. However other designs of the distance sensor are also possible, such as an infrared sensor, a laser sensor, or an imaging sensor.

The set position sensor of the forward-looking monitoring device can be in the form of a rotation angle sensor which is arranged on a suitable joint of the front-loading mechanism and is connected to the electronic control unit by an electric sensor line.

Alternatively, or in addition in order to provide redundancy, the set position sensor of the forward-looking monitoring device can be in the form of a pressure sensor which is connected to a suitable actuating cylinder of the front-loading mechanism and is connected to the electronic control unit by an electric sensor line.

If the transmission of the working machine is in the form of an electronically controlled CVT transmission, an emergency braking operation can be assisted by continuously increasing the transmission ratio of the transmission. CVT transmissions are usually conical-disk wrap-around transmissions whose transmission ratio can be varied continuously.

If the transmission of the working machine is in the form of an electronically controlled change-speed transmission and can be shifted to its neutral position, in which the power transfer between a drive motor and a drive axle is interrupted, an emergency braking operation can be assisted by cutting off the drive-power of the drive motor and likewise by an appropriate actuation of the transmission.

If an electronically controlled separator clutch is provided in the drivetrain of the working machine, and the power transfer between the drive motor and the drive axle can be interrupted by disengaging the separator clutch, then an emergency braking operation of the working machine can also be assisted by correspondingly actuating the separator clutch.

As mentioned at the beginning, the invention also relates to a method for controlling a safety function of a mobile working machine that comprises a front-loading mechanism with a loading device that can be raised and lowered, which comprises a hydraulic or pneumatic brake unit with at least one electronically controlled brake circuit and which bas a central control unit by means of which the brake circuit can be controlled, at least indirectly, and a safety function of the working machine can be operated.

To achieve the method-related objective, it is provided that by means of at least one distance sensor of a forward-looking monitoring device arranged at the front of the working machine, the distance of the working machine from an obstacle ahead of the working machine is determined, and depending on how large that distance is, a warning signal is emitted and/or an emergency braking operation is carried out.

Thus, this method for controlling a safety function of a mobile working machine serves to avoid a collision with an obstacle ahead of the working machine. It is assumed that the mobile working machine has a front-loading mechanism with a loading device that can be raised and lowered and with a hydraulic or pneumatic brake unit, and with at least one electronically controlled brake circuit. By the sensor-determined distance of the working machine from an obstacle ahead of the working machine, if the distance to the obstacle reaches or falls below a higher value, a warning signal is emitted, and/or if the distance to the obstacle reaches or falls below a lower value, an emergency braking operation is initiated and carried out.

To avoid any interference with the distance sensor and a consequent control error of the safety function, according to a further development of the method, it is provided that by means of a set position sensor of a front load monitoring device arranged on the front-loading mechanism the current position of the loading device is determined, and depending on whether the loading device is outside or within a detection range of the distance sensor, the safety function is activated or deactivated.

For that purpose, the adjustment range of the loading device is divided into an upper adjustment range in which the loading device is outside the detection range of the distance sensor, and a lower adjustment range in which the loading device is within the detection range of the distance sensor. The safety function is then activated if the current set position of the loading device is within the upper adjustment range, and deactivated if the current set position of the loading device is within the lower adjustment range. In that way, an obstruction of the distance sensor resulting in erroneous control of the safety function is largely excluded.

Since the safety function is restricted to monitoring of the area ahead of the building machine, as a further design feature of the method it can be provided that by means of at least one acceleration sensor and/or by means of at least one wheel rotation speed sensor, the current travel direction of the working machine is determined, and the safety function is activated if the working machine is travelling forward, and is deactivated if the working machine is reversing or is at a standstill.

To warn the driver of the working machine about a possible collision with an obstacle and the possible triggering of an emergency braking operation, it can also be provided that, for example, in the driver's cabin of the working machine an acoustic and/or visual warning signal is emitted if the distance determined reaches or falls below a specified first, upper distance limit value.

By a corresponding actuation of the electronically controlled brake circuit of the brake unit, an emergency braking operation is then preferably triggered if the distance determined reaches or falls below a predetermined lower, second distance limit value.

Since the braking travel of a vehicle increases quadratically with the speed of the vehicle, a plurality of distance limit values is preferably specified for different forward driving speeds, such that the distance limit speeds increase quadratically with increasing forward driving speed.

Alternatively, the specified distance limit values can also be multiplied by a speed-dependent correction factor K which increases quadratically with increasing forward driving speed.

In another further development of the method, a braking value signal emitted for the emergency braking operation to an electronic brake control unit can advantageously be determined as a function of the forward driving speed, such that the braking value signal increases with increasing forward driving speed. A quadratic increase of the braking value signal is not unconditionally necessary, since at higher forward driving speeds the emergency braking operation will be initiated earlier, i.e., at a larger distance from the obstacle.

To assist an emergency braking operation of the working machine, when a trailer vehicle is coupled to the working machine, and if an emergency braking operation is triggered, an electronically controlled trailer control valve of the working machine is actuated in such manner that the trailer vehicle is also braked.

An emergency braking operation of the working machine can also be assisted if, when an emergency braking operation is triggered, an electronically controlled drive motor of the working machine is actuated in such manner that it works in overdrive mode or, when the emergency braking operation is triggered, the transmission ratio of a driving transmission in the form of an electronically controlled CVT transmission of the working machine is increased continuously, or when the emergency braking operation is triggered, an electronically controlled change-speed driving transmission of the working machine is shifted to its neutral position in which the power flow between a drive motor and the at least one drive axle is interrupted, or when the emergency braking operation is triggered, an electronically controlled separator clutch arranged in the drivetrain of the working machine is disengaged in order to interrupt the power transfer between the drive motor and the drive axle.

Below, the invention will be explained in greater detail with reference to an example embodiment illustrated in the attached drawing, which shows:

### BRIEF DESCRIPTION OF THE DRAWINGS

FIG. 1: A mobile working machine with a front-loading mechanism in a first working position,

FIG. 2: The working machine of FIG. 1 in a second working position, and

FIG. 3: A brake unit of a mobile working machine, illustrated schematically.

### DETAILED DESCRIPTION

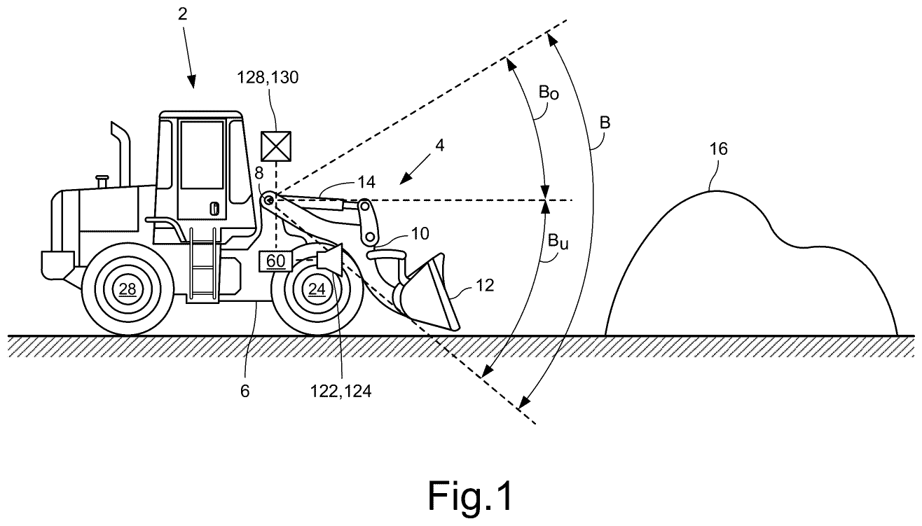

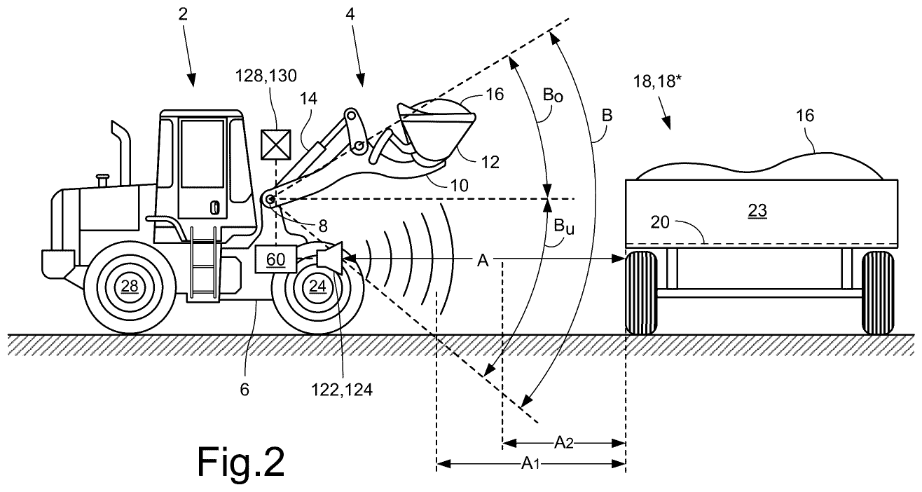

The mobile working machine 2 shown in FIGS. 1 and 2 is in the form of a wheel loader and comprises a vehicle chassis 6, on which a front axle 24 and a rear axle 28 are suspended. The rear axle 28 is the drive axle of the working machine 2. At the front of the wheel loader 2 is arranged a front-loading mechanism 4 with a loading device 12 that can be raised and lowered, which is in the form of a loading scoop. The front-loading mechanism 4 has a carrier arm 10 which is mounted pivotably about a joint 8 on the vehicle chassis 6 of the wheel loader 2 and which can be swiveled up or down by means of a hydraulic positioning cylinder 14.

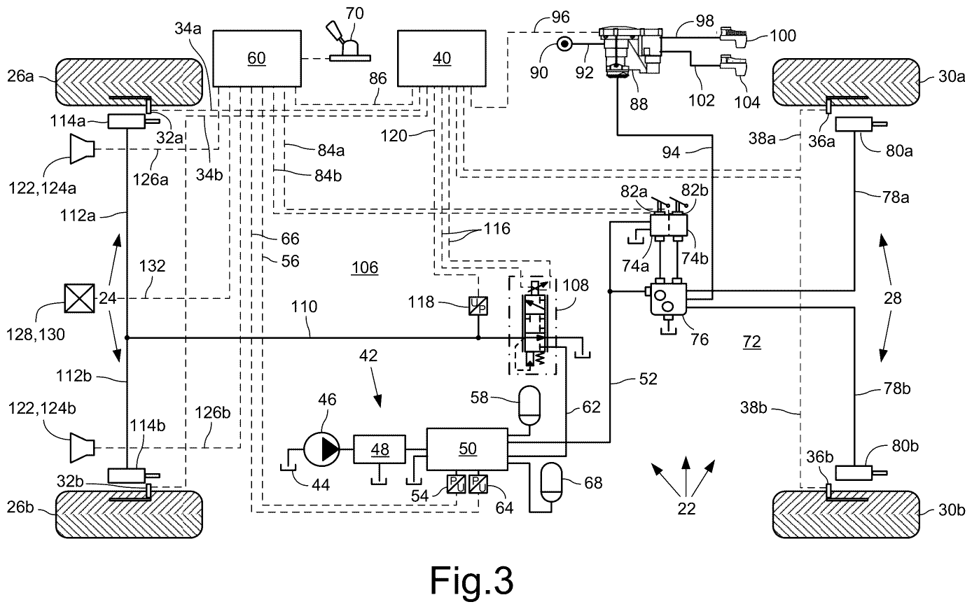

The wheel loader 2 has a hydraulic brake unit 22 with an electronically controlled brake circuit which is illustrated schematically in FIG. 3, and whose structure and functional mode are explained below. In addition, the wheel loader 2 comprises a forward-looking monitoring device 122 with at least one distance sensor 124 arranged at the front of the working machine 2 for determining the distance to an obstacle 18, 18* located ahead of the working machine 2, and a front load monitoring device 128 with a set position sensor 130 on the front-loading mechanism 4 for determining the current position of the loading device 12, in this case the loading scoop 12. The set position sensor 130 can be in the form of a rotation angle sensor, which is arranged on the joint 6 of the front-loading mechanism 4 and is connected by an electric sensor line 132 to a central electronic control unit 60 of the working machine 2. Alternatively, the set position sensor 130 can also be in the form of a pressure sensor which is connected to the positioning cylinder 14 of the front-loading mechanism 4 and is connected by an electric sensor line 132 to the central control unit 60.

A safety function for avoiding a collision of the worlding machine 2 with an obstacle 18, 18* located ahead of the working machine 2 provides that by means of the distance sensor 124 of the forward-looking monitoring device 12 the distance to an obstacle 18, 18* ahead of the working machine 2 is determined, and as a function of the distance determined a warning signal is emitted and/or an emergency braking operation is initiated and carried out. Furthermore, it is provided that by means of the set position sensor 130 of the front load monitoring device 128, the current position of the loading device 12, in this case the loading scoop 12, is detected and that depending on whether the loading device 12 is outside or within the detection range of the distance sensor 124, the safety function is activated or deactivated.

For that purpose, the position range B of the loading device 12 is divided into an upper position range Bₒ in which the loading device 12 is outside the detection range of the distance sensor 124, and a lower position range Bᵤ in which the loading device 12 is within the detection range of the distance sensor 124. The safety function is activated when the current set position of the loading device 12 is within the upper position range Bₒ and deactivated when the current set position of the loading device 12 is within the lower position range Bᵤ.

In FIG. 1 the working machine 2 is shown in a first working position in which the working machine 2 is ready with its loading scoop 12 to take up a load by driving forward into a heap of bulk material 16 ahead of the working machine 2, such as sand, maize, or grain. Since the lowered loading scoop 12 is within the lower position range Bᵤ and therefore within the detection range of the distance sensor 124, the safety function is in this case deactivated.

In FIG. 2, the working machine 2 is shown in a second working position in which the working machine 2, with its loading scoop 12 raised, is ready to unload previously taken up balk material 16 onto the load platform 20 of a trailer vehicle 18* parked in front of the working machine 2. This trailer vehicle 18* represents the obstacle 18 already mentioned. Since the raised loading scoop 12 is within the upper position range Bo and therefore outside the detection range of the distance sensor 124, the safety function is activated in this case. To avoid an undesired collision of the working machine 2 with the trailer vehicle 18* as the working machine 2 moves farther forward, the safety function, which is also activated only when travelling forward, provides that in the driver's cabin of the working machine 2 an acoustic and/or visual warning signal is emitted when the distance A detected between the working machine 2 and the trailer vehicle 18* has reached or fallen below a predetermined, higher first distance limit value A₁.

As the working machine 2 approaches closer to the trailer vehicle 18*, the safety function provides that by an appropriate actuation of the electronically controlled brake circuit 106 of the brake unit 22 an emergency braking operation is initiated and carried out when the distance A determined has reached or fallen below a predetermined, lower second distance limit value A₂ (A≤A₂). The two distance limit values A₁, A₂ mentioned can be determined variably as a function of the driving speed of the working machine 2, and made higher as the driving speed v_{F} increases, in particular quadratically as the driving speed v_{F} increases (A₁~v_{F}², A₂~v_{F}²).

Likewise, a braking signal value emitted for the emergency braking operation to an electronic brake control unit 40 of the brake unit 22 can be determined variably as a function of the forward driving speed v_{F}, in such manner that the braking signal value increases with increasing forward driving speed v_{F}. If the brake unit 22 comprises an electronically controlled trailer control valve 88 as shown in FIG. 3, then an emergency braking operation of a trailer vehicle 18* coupled to the working machine 2 can also be assisted by a corresponding actuation of the trailer control valve 88 and the braking of the trailer vehicle 18* is supported thereby.

In the schematic illustration shown in FIG. 3, a brake unit 22 of such a mobile working machine 2 is shown, in which the features comprised in the method according to the invention can be used. The working machine 2 has a non-driven front axle 24 with two front wheels 26a, 26b on its two respective sides, and a rear axle 28 forming the drive axle with two rear wheels 30a, 30b on its two respective sides. On the wheels 26a, 26b, 30a, 30b of the two vehicle axles there is in each case arranged a respective wheel rotation speed sensor 32a, 32b, 36a, 36b, which are connected by sensor lines 34a, 34b, 38a, 38b to the already mentioned brake control unit 40. By means of the brake control unit 40 the driving direction and the driving speed v_{F} of the working machine 2 can be determined from the sensor signals of the wheel rotation speed sensors 32a, 32b, 36a, 36b.

The brake unit 22 comprises a hydraulic primary brake unit 72 and a hydraulic secondary brake unit 106, as well as the aforesaid pneumatic trailer control valve 88. A hydraulic pressure medium source 42 comprises an oil pump 46 by which hydraulic oil can be delivered from a hydraulic reservoir 44, via a relay valve 48, to a hydraulic medium preparation device 50. In the hydraulic medium preparation device 50 the hydraulic oil supplied is cleaned, cooled and passed into two supply lines 52, 62. To these two supply lines 52, 62 are connected in each case a hydraulic pressure sensor 54, 64 and a hydraulic pressure reservoir 58, 68. The two pressure sensors 54, 64 are connected by respective sensor lines 56, 66 to the central control unit 60 of the working machine 2. Also connected to the control unit 60 is an operating element 70 in the form of a driving direction lever, by means of which the driving direction of the working machine 2, i.e. forward or in reverse, can e selected.

The primary brake unit 72 can be used as a service brake unit and as a steering brake unit, and in this case comprises two brake circuits, each associated with a respective side of the vehicle. The primary brake unit 72 comprises the first supply line 52 with the associated hydraulic pressure reservoir 58, two foot-brake valves 74a, 74b that can each be actuated mechanically by a respective brake pedal, at axle relay valve 76, and two wheel-brake lines 78a, 78b. The two foot-brake valves 74a, 74b are connected on their inlet side to the supply line 52 and on their outlet side to the axle relay valve 76. The axle relay valve 76 is also connected to the supply line 52. The two wheel-brake lines 78a, 78b extend from the axle relay valve 76 each to a respective wheel-brake cylinder 80a, 80b. The two wheel-brake cylinders 80a, 80b are in the form of actively working membrane or piston brake cylinders and are arranged on the wheel brakes of the rear axle 30a, 30b.

When operating as a service brake unit, the brake pedals of the foot-brake valves 74a, 74b are mechanically coupled to one another, so that when one of the two brake pedals is actuated the two wheel-brake cylinders 80a, 80b are acted upon by the same brake pressure and the working vehicle 2 is thereby braked without track deviation. When operating as a steering brake, the brake pedals are mechanically separated, so that when one of the two brake pedals is actuated, only its associated wheel brake cylinder 80a, 80b is acted upon by braking pressure and thereby a curved or turning maneuver of the working vehicle 2 in the direction concerned is assisted.

By means of adjustment path sensors 82a, 82b arranged on the two foot-brake valves 74a, 74b, the adjustment path of the valve piston concerned is detected and in each case is transmitted by way of respective electric sensor lines 84a, 84b to the central control unit 60 in which, from the adjustment path signal concerned, a braking value signal can be formed. The central control unit 60 is connected to the brake control unit 40 by a data bus such as a CAN bus.

The trailer control valve 88 is connected on its input side, via a third supply line 92, to a pressure source 90 and via a brake control line 94 to the axle relay valve 76 of the primary brake unit 72. Furthermore, the trailer control valve 88 is connected via an electric control line 96 to the brake control unit 40 and can thereby also be controlled electronically. During normal operation the supply pressure applied on the input side, reduced as necessary by the trailer control valve 88, is passed through, and on the output side delivered via a fourth supply line 98 to a “supply” clutch head (red) 100. Moreover, in the trailer control valve 88, depending on the brake pressure in the brake control line 94 and/or a control signal transmitted by way of the control line 96, a brake control pressure is set, which is passed by way of a brake control line 102 to a “brake” clutch head (yellow) 104. When a trailer vehicle is coupled, its pressure-operated brake unit is supplied with the supply pressure applied at the “supply” clutch head 100 and controlled as a function of the brake control pressure at the “brake” clutch head 104.

The secondary brake unit 106 is designed to be controlled electronically and can be used at least as an auxiliary brake unit by the function of which the working machine 2 can be reliably braked in the event that the primary brake unit 72 fails. The secondary brake unit 106 has only one brake circuit and comprises the second supply line 62 with the associated pressure reservoir 68, a brake control valve 108, an axle brake line 110 that branches into two wheel brake lines 112a, 112b, and two wheel-brake cylinders 114a, 114b, each connected respectively to one of the wheel-brake lines 112a, 112b. The two wheel-brake cylinders 114a, 114b are in the form of actively effective membrane or piston brake cylinders and are arranged on the wheel brakes of the front wheels 26a, 26b.

The brake control valve 108 is in the form of a 3/3-way proportional magnetic valve with a pressure medium inlet, a pressure medium outlet, and a working connection, wherein the working connection can be adjusted continuously between a connection with the pressure medium outlet and the pressure medium inlet. The pressure medium inlet is connected via the second supply line 62 to the hydraulic pressure medium source 42, the pressure medium outlet is connected to an unpressurized hydraulic collecting container, and the working connection is connected via the axle brake line 110 to the wheel-brake cylinders 114a, 114b. By appropriate actuation of the brake control valve 108, the brake pressure present in the axle brake line 110 and in the wheel-brake cylinders 114a, 114b connected to the axle brake line 110 can be adjusted between a minimum pressure corresponding to the pressure of the surroundings and a maximum pressure corresponding to the supply pressure present in the supply line 62.

The electromagnet of the brake control valve 108 can be actuated by way of a two-core electric control line 116, directly by the brake control unit 40. When not energized, the working connection of the brake control valve 108 is connected to the pressure medium outlet and in its maximally energized state it is connected, unthrottled, to the pressure medium inlet. To determine and monitor the brake pressure set via the brake control valve 108 in the axle brake line 110, an electro-hydraulic pressure sensor 118 is connected to the axle brake line 110, which sensor is connected to the brake control unit 40 by an electric sensor line 120. Thus, the secondary brake unit 106 can be controlled purely electronically. The brake pressure in the axle brake line 110 and in the wheel-brake cylinders 114a, 114b connected to the axle brake line 110 can therefore be adjusted as a function of a braking value signal independently of the primary brake unit 72, which signal can be determined in the brake control unit 40 from the sensor signals emitted by the adjustment path sensors 82a, 82b or in some other way.

To carry out the safety function, in FIG. 3 two distance sensors 124a, 124b of the forward-looking monitoring device 12, preferably in the form of ultrasonic sensors, and a set position sensor 130 of the front load monitoring device 128, are shown. The two distance sensors 124a, 124b are arranged offset to the side on the front of the working machine 2 and are connected by electric sensor lines 126a, 126b to the central control unit 60. As shown in FIGS. 1 and 2, the set position sensor 130 is arranged on the front-loading mechanism 4 and connected by an electric sensor line 132 to the central control unit 60.

### LIST OF INDEXES (PART OF THE DESCRIPTION)

2 Mobile working machine, wheel loader
4 Front-loading mechanism
6 Vehicle chassis
8 Joint
10 Carrier arm
12 Loading device, loading scoop
14 Positioning cylinder
16 Bulk goods
18 Obstacle
18* Trailer vehicle, obstacle
20 Loading platform
22 Brake unit
24 Front axle
26a First front wheel
26b Second front wheel
28 Rear axle, drive axle
30a First rear wheel
30b Second rear wheel
32a First wheel rotation speed sensor
32b Second wheel rotation speed sensor
34a First sensor line
34b Second sensor line
36a Third wheel rotation speed sensor
36b Fourth wheel rotation speed sensor
38a Third sensor line
38b Fourth sensor line
40 Brake control unit
42 Hydraulic pressure medium source
44 Collecting container, hydraulic reservoir
46 Oil pump
48 Relay valve
50 Pressure medium preparation device
52 First supply line
54 First pressure sensor
56 Fifth sensor line
58 First pressure reservoir
60 Central control unit
62 Second supply line
64 Second pressure sensor
66 Sixth sensor line
68 Second pressure reservoir
70 Operating element, driving direction lever
72 Primary brake unit
74a First foot-brake valve
74b Second foot-brake valve
76 Axle relay valve
78a First wheel brake line
78b Second wheel brake line
80a First wheel brake cylinder
80b Second wheel brake cylinder
82a First adjustment path sensor
82b Second adjustment path sensor
84a Seventh sensor line
84b Eighth sensor line
86 Data bus, CAN bus
88 Trailer control valve
90 Compressed-air source
92 Third supply line
94 First brake control line
96 First control line
98 Fourth supply line
100 “Supply” clutch head (red)
102 Second brake control line
104 “Brake” clutch head (yellow)
106 Secondary brake unit
108 Brake control valve
110 Axle brake line
112a Third wheel-brake line
112b Fourth wheel-brake line
114a Third wheel-brake cylinder
114b Fourth wheel-brake cylinder
116 Second control line
118 Third pressure sensor
120 Ninth sensor line
122 Forward-looking monitoring device
124 First distance sensor, ultrasonic sensor
124a Second distance sensor, ultrasonic sensor
124b Third distance sensor, ultrasonic sensor
126a Tenth sensor line
126b Eleventh sensor line
128 Front load monitoring device
130 Set position sensor, rotation angle sensor or pressure sensor
132 Twelfth sensor line
A Distance detected
A₁ First distance limit value
A₂ Second distance limit value
B Adjustment range, swiveling range
Bₒ Upper adjustment range, upper swiveling range
Bᵤ Lower adjustment range, lower swiveling range
K Correction factor
v_{F} Vehicle speed, forward driving speed

1. A mobile working machine (2) with a front-loading mechanism (4) which comprises a loading device (12) that can be raised and lowered, with a hydraulic or pneumatic brake unit which comprises at least one electronically controlled brake circuit (106), and with a central control unit (60) by means of which the brake circuit (106) can be controlled at least indirectly and by which a safety function of the working machine (2) can be operated, wherein to carry out the safety function and thereby to avoid a collision with an obstacle (18, 18*) ahead of the working machine (2), the mobile working machine further comprises the following components connected for the exchange of signals to the central control unit (60):
a forward-looking monitoring device (122) with at least one distance sensor (124, 124a, 124b) arranged at the front of the working machine (2) for determining the distance (A) of the working machine (2) from an obstacle (18, 18*) ahead of the working machine (2); and
a front load monitoring device (128) with a set position sensor (130) arranged on the front-loading mechanism (4) for determining the current set position of the loading device (12).

2. The mobile working machine according to claim 1, wherein the at least one distance sensor (124, 124a, 124b) of the forward-looking monitoring device (122) is in the form of an ultrasonic sensor and is connected by an electric sensor line (126a, 126b) to an electronic control unit (60).

3. The mobile working machine according to claim 1, wherein the set position sensor (130) of the front load monitoring device (128) is in the form of a rotation angle sensor, is arranged on a suitable joint (8) of the front-loading mechanism and is connected by an electric sensor line (132) to the electronic control unit (60).

4. The mobile working machine according to claim 1, wherein the set position sensor (130) of the front load monitoring device (128) is in the form of a pressure sensor, is connected to a positioning cylinder (14) of the front-loading mechanism and is connected by an electric sensor line (132) to the electronic control unit (60).

5. The mobile working machine according to claim 1, wherein the drive transmission of the working machine (2) is in the form of an electronically controlled CVT transmission whose transmission ratio can be varied continuously.

6. The mobile working machine according to claim 1, wherein the drive transmission of the working machine (2) is in the form of an electronically controlled change-speed transmission, and the drive transmission can be shifted to a neutral position in which the power flow between a drive motor of the working machine (2) and at least one drive axle (28) of the working machine (2) is interrupted.

7. The mobile working machine according to claim 1, comprising an electronically controlled separator clutch arranged in the drive-train of the working machine (2), wherein a power flow between the drive motor and the at least one drive axle (28) can be interrupted by disengaging the separator clutch.

8. A method for controlling a safety function of a mobile working machine (2) that comprises a front-loading mechanism (4) comprising a loading device (12) which can be raised and lowered, the front-loading mechanism having a hydraulic or pneumatic brake unit (22) with at least one electronically controlled brake circuit (106), the mobile working machine further comprising a central control unit (60) by means of which the brake circuit (106) can be controlled, at least indirectly, and by which a safety function of the working machine (2) can be operated, the method comprising:
determining, by means of at least one distance sensor (124, 124a, 124b) of a forward-looking monitoring device (122) arranged at the front of the working machine (2), the distance (A) of the working machine (2) from an obstacle (18, 18*) ahead of the working machine (2); and
emitting a warning signal and/or carrying out an emergency braking operation based on the distance (A) determined.

9. The method according to claim 8, comprising:
determining, by means of at least one set position sensor (130) arranged on the front-loading mechanism (4), the current set position of the loading device (12); and
activating or deactivating the safety function depending on whether the loading device (12) is outside or within a detection range of the distance sensor (130).

10. The method according to claim 9 comprising:
dividing a position range (B) of the loading device (12) into an upper position range (Bₒ), in which the loading device (12) is outside the detection range of the distance sensor (130), and a lower position range (Bᵤ), in which the loading device (12) is within the detection range of the distance sensor (130); and
determining a current set position of the loading device;
activating the safety function when the current set position of the loading device (12) is within the upper position range (Bₒ), and deactivating the safety function when the current set position of the loading device (12) is within the lower position range (Bᵤ).

11. The method according to claim 8, comprising:
determining, by means of at least one acceleration sensor and/or by means of at least one wheel rotation speed sensor (32a, 32b, 36a, 36b), a current travel direction of the working machine (2); and
activating the safety function is activated when the working machine (2) is moving forward and deactivating when the working machine (2) is reversing or at a standstill.

12. The method according to claim 8, comprising:
determining that the distance (A) has reached or fallen below a predetermined first, higher distance travel limit value (A₁); and
emitting an acoustic and/or visual warning signal.

13. The method according to claim 12, comprising:
Determining that the distance (A) has reached or fallen below a predetermined second, lower distance limit value (A₂); and
initiating an emergency braking operation, by actuating the electronically controlled brake circuit (106) of the brake (22).

14. The method according to claim 13, comprising:
providing a plurality of distance limit values (A₁, A₂) for different forward driving speeds (v_{F}), such that the distance limit values (A₁, A₂) increase quadratically with increasing forward driving speed (v_{F}).

15. The method according to claim 13, comprising
multiplying the predetermined distance limit values (A₁, A₂) by a speed-dependent correction factor (K), wherein the correction factor (K) increases quadratically with increasing forward travel speed v_{F} (K~v_{F}²).

16. The method according to claim 13, comprising:
determining a brake value signal emitted for an emergency braking operation to an electronic brake control unit (40) variably as a function of the forward travel speed (v_{F}), in such manner that the braking value signal increases with increasing forward travel speed (v_{F}).

17. The method according to claim 8, wherein a trailer vehicle (23) is coupled to the working machine (2), the method further comprising:
triggering an emergency braking operation; and
actuating an electronically controlled trailer control valve (88) of the working machine (2) in such manner that the trailer vehicle is braked.

18. The method according to claim 8, comprising:
triggering an emergency braking operation; and
controlling an electronically controlled drive motor of the working machine (2) in such manner as to operate in an overdrive mode.

19. The method according to claim 8, comprising:
triggering an emergency braking operation; and
increasing continuously the transmission ratio of a drive transmission of the working machine (2) in the form of an electronically controlled CVT transmission.

20. The method according to claim 8, comprising:
triggering an emergency braking operation; and
shifting a drive transmission of the working machine (2) in the form of an electronically controlled change-speed transmission to a neutral position, in which the power flow between a drive motor and at least one drive axle (28) is interrupted.

21. The method according to claim 8, comprising:
triggering an emergency braking operation; and
disengaging an electronically controlled separator clutch arranged in the drive-train of the working machine (2), whereby the power flow between the drive motor and the drive axle (28) is interrupted.
